(19) United States
(12) Patent Application Publication
(10) Pub. No.: US 2013/0238414 A1
(43) Pub. Date: Sep. 12, 2013

(54) INFORMATION PROCESSING APPARATUS AND INFORMATION PROCESSING METHOD

(71) Applicant: TOSHIBA TEC KABUSHIKI KAISHA, Tokyo (JP)

(72) Inventors: Naoko Higuchi, Kanagawa-ken (JP); Taro Ando, Shizuoka-ken (JP)

(73) Assignee: TOSHIBA TEC KABUSHIKI KAISHA, Tokyo (JP)

(21) Appl. No.: 13/786,714

(22) Filed: Mar. 6, 2013

(30) Foreign Application Priority Data
Mar. 6, 2012 (JP) 2012-049667

(51) Int. Cl. G06Q 30/02

(52) U.S. Cl. CPC G06Q 30/0226
USPC 705/14.27

(57) ABSTRACT

An information processing apparatus comprises: a judgment unit configured to refer to a point return rate storage unit storing a second point return rate different from a first point return rate and a first condition for changing a point return rate into the second point return rate to judge whether or not a received order is consistent with the first condition; and a point calculation unit configured to calculate a point number by using the first point return rate if the order is inconsistent with the first condition, and calculate the point number by using the second point return rate if the order is consistent with the first condition, wherein the second point return rate and the first condition are changed with a fourth point return rate different from a third point return rate and a second condition for changing into the fourth point return rate.

### CROSS-REFERENCE TO RELATED APPLICATION

This application is based upon and claims the benefit of priority from Japanese Patent Application No. 2012-049667, filed Mar. 6, 2012, the entire contents of which are incorporated herein by reference.

### FIELD

Embodiments described herein relate to an information processing apparatus and an information processing method.

### BACKGROUND

Conventionally, in a point service system, a point corresponding to a commodity purchase amount was calculated when a commodity was purchased, and the point was granted to each customer. In addition, along with the popularization of an internet, a form carrying out the sale of the commodity online is added, and meanwhile, the sales form of a so-called “net super” is utilized. For such point granting at net procurement, various technologies are proposed. For example, the following technology reading out the point from a recording medium (card) for allocating a point record to each user and carrying out the addition and the subtraction of the point with a point management apparatus for point management, which is connected with the internet, when the commodity is purchased from a online shop is disclosed.

### BRIEF DESCRIPTION OF THE DRAWINGS

FIG. 1 is a system structure diagram summarily illustrating the structure of a point system of an embodiment;

FIG. 2 is a external oblique view summarily illustrating the structure of a POS terminal;

FIG. 3 is a block diagram illustrating the structure of an electric system of the POS terminal;

FIG. 4 is a block diagram illustrating the structure of an electric system of a store computer;

FIG. 5 is a schematic diagram illustrating the data structure of a point return rate change file;

FIG. 6 is a block diagram illustrating the structure of an electric system of an application server;

FIG. 7 is a schematic diagram illustrating the data structure of the point return rate change file;

FIG. 8 is a diagram illustrating a software structure that a control unit has;

FIG. 9 is a block diagram illustrating the structure of an electric system of a member server;

FIG. 10 is a flowchart illustrating the procedures of order receiving processing executed by the application server;

FIG. 11 is a flowchart illustrating the procedures of slip generation processing;

FIG. 12 is a diagram illustrating an example of a member code;

FIG. 13 is a diagram illustrating an example of a point code;

FIG. 14 is a diagram illustrating an example of a delivery slip generated in the slip generation processing;

FIG. 15 is a diagram illustrating an example of the delivery slip generated in the slip generation processing; and

FIG. 16 is a flow chart illustrating the procedures of sales processing executed on the POS terminal.

### DETAILED DESCRIPTION

In accordance with an embodiment, an information processing apparatus comprises: an order receiving unit configured to receive the order of commodity purchase from a terminal connected through a network; a judgment unit configured to refer to a point return rate storage unit which stores a second point return rate different from a predetermined first point return rate for calculating a point number corresponding to a commodity purchase amount and a first condition for changing into the second point return rate to judge whether or not the received order is consistent with the first condition; and a point calculation unit configured to calculate the point number corresponding to the commodity purchase amount of the order by using the first point return rate in a status that the judgment unit judges that the received order is inconsistent with the first condition, and calculate the point number corresponding to the commodity purchase amount of the order by using the second point return rate in a status that the judgment unit judges that the received order is consistent with the first condition, wherein the second point return rate and the first condition which are stored in the point return rate storage unit are changed together with a fourth point return rate different from a predetermined third point return rate for calculating the point number in the commodity sales processing in a real store and a second condition for changing into the fourth point return rate.

In accordance with an embodiment, an information processing method comprises: receiving the order of commodity purchase from a terminal connected through a network; referring to a point return rate storage unit that stores a second point return rate different from a predetermined first point return rate for calculating a point number corresponding to a commodity purchase amount and a first condition for changing into the second point return rate and the second point return rate and the first condition which are stored in the point return rate storage unit are changed together with a fourth point return rate different from a predetermined third point return rate for calculating the point number in the commodity sales processing in a real store and a second condition for changing into the fourth point return rate, to judge whether or not the received order is consistent with the first condition; and calculating the point number corresponding to the commodity purchase amount of the order by using the first point return rate in a status that is judged that the received order is inconsistent with the first condition, and calculating the point number corresponding to the commodity purchase amount of the order by using the second point return rate in a status that is judged that the received order is consistent with the first condition.

Hereinafter, the embodiments of the information processing apparatus and the program to which the present invention relates will be described in detail with reference to the drawings. In addition, the invention is not limited to the embodiments described below.

A point service system of the present embodiment issues a point card recording each inherent member number on a recording medium such as a magnetic tape and the like for each customer subscribing as a member, for example, a store implementing such a point service institution granting a service point (hereinafter, called as point) with a specified point return rate for the commodity purchase amount (sales volume) of the customer holding the point card utilizes the point service system of the present embodiment.

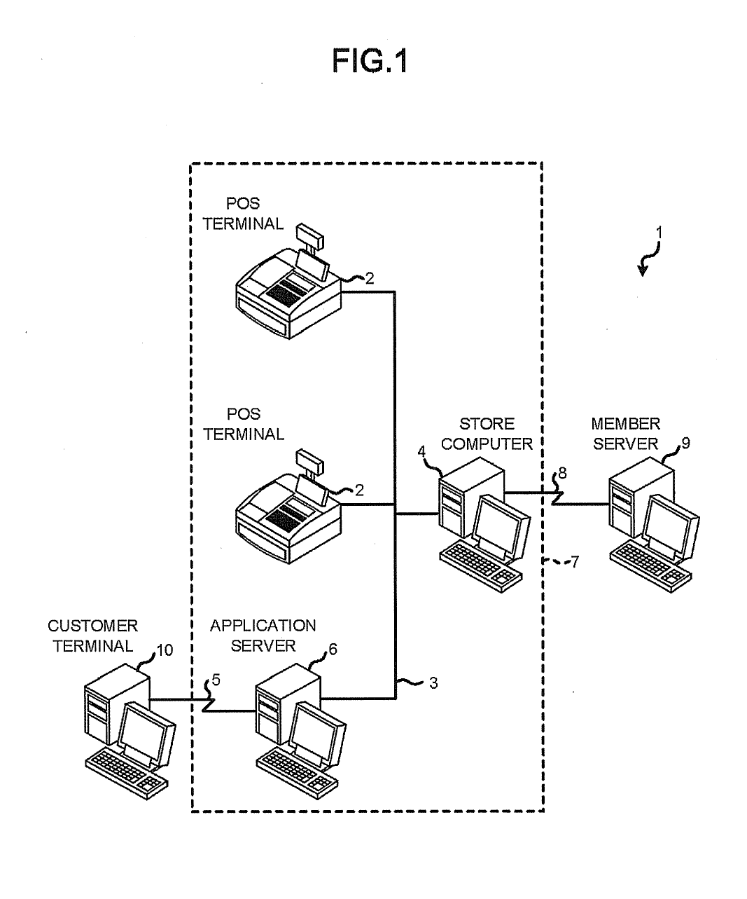

FIG. 1 is a system structure diagram summarily illustrating the structure of a point system 1. As shown in FIG. 1, the point system 1 comprises a POS system 7 and a server computer (hereinafter, called as member server) 9 connected with a store computer 4 through a special circuit 8, and the POS system 7 consists of a plurality of POS (Point of Sales) terminals 2, the store computer 4 connecting these POS terminals 2 by using an LAN 3 and carrying out centralized management, and an application server 6 serving as the information processing apparatus providing a network super service for a customer terminal 10 connected through a WAN 5.

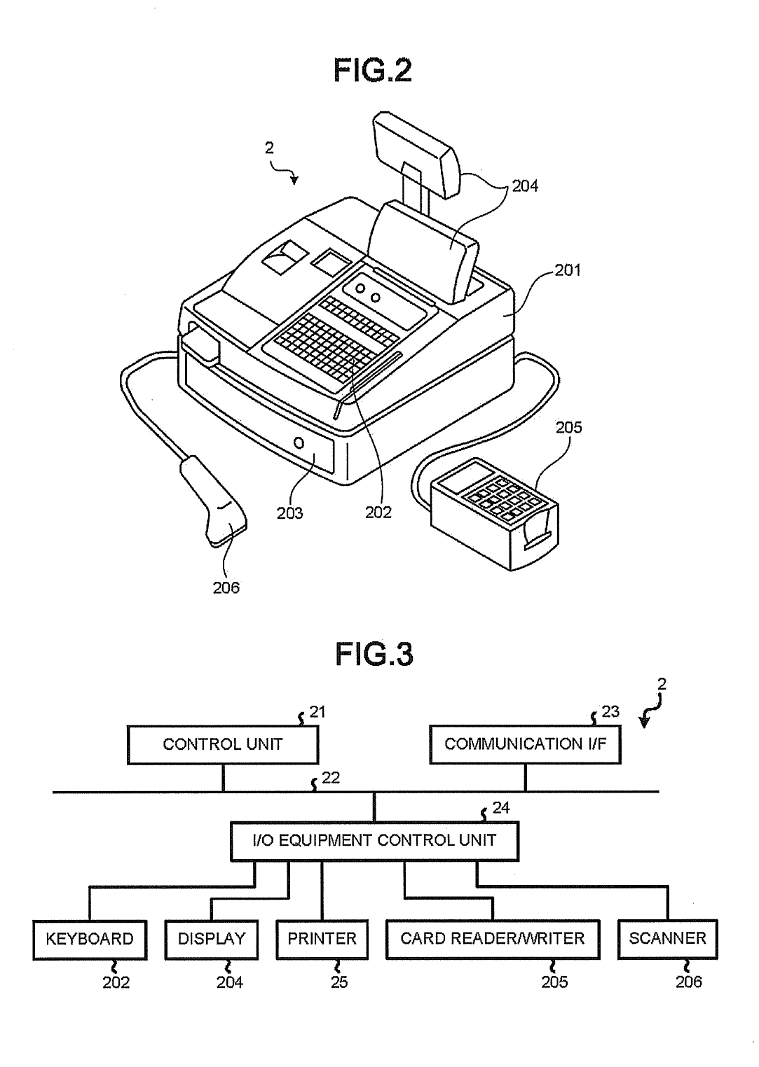

The POS terminal 2 is a terminal which is configured at a settlement position and is used for a cashier to carry out sales processing, and has a structure as shown in FIG. 2. Herein, FIG. 2 is a external oblique view summarily illustrating the structure of the POS terminal 2. In the POS terminal 2, a keyboard 202 is arranged at the side of the upper surface of a main body 201, a drawer 203 is arranged at the side of the lower portion of the main body 201 in the manner that it can be freely pulled out, and displays 204 are arranged at the inner side of the main body 201. In addition, the POS terminal 2 is connected with a card reader/writer 205 receiving the insertion of a member card serving as a magnetic card and carrying out the reception and the sending of data between the member cards, a code scanner 206 for reading a commodity code or the following point code in an optical manner, and the like.

An electric system of such a POS terminal 2 has a structure as shown in FIG. 3. FIG. 3 is a block diagram illustrating the structure of the electric system of the POS terminal 2. The POS terminal 2 is formed to comprise a control unit 21 consisting of a computer comprising a CPU (Central Processing Unit), an ROM (Read Only Memory) storing various control programs for executing the following sales processing and the like by synergistically acting with the CPU, an RAM (Random Access Memory) and the like, and can mutually execute online communication with the store computer 4 through the LAN 3 from a communication interface 23 connected through a bus 22.

Moreover, the control unit 21 is connected with the keyboard 202, the displays 204, the card reader/writer 205 and the code scanner 206 through the bus 22 and an I/O equipment control unit 24, and is also connected with a printer 25 serving as a receipt/journal pointer. The printer 25 is a printer printing receipt paper or journal paper along with the sales processing, and moreover, is arranged inside the main body 201 or outside the main body 201.

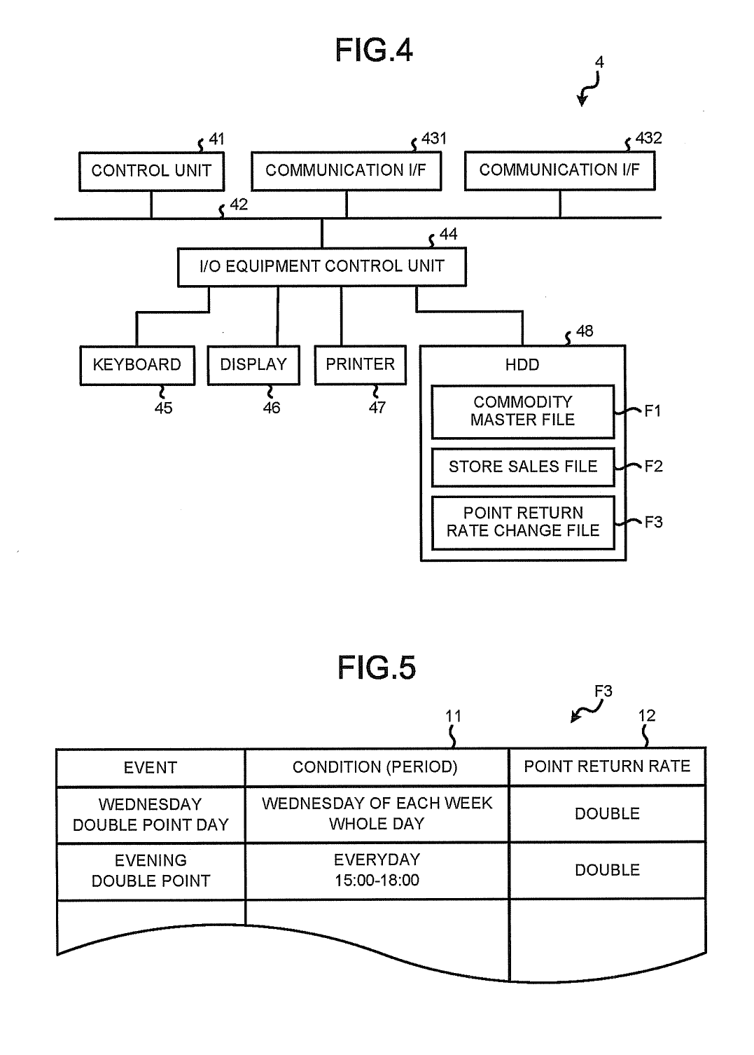

Next, the store computer 4 is described. The store computer 4 takes charge of the control of the POS system 7, and its electric system, for example, has a structure as shown in FIG. 4. FIG. 4 is a block diagram illustrating the structure of the electric system of the store computer 4. The store computer 4 is formed to be capable of mutually executing the online communication with the plurality of POS terminals 2 through the LAN 3 from a control unit 41 consisting of a computer comprising a CPU, an ROM, an RAM and the like and a communication interface 431 connected through a bus 42. In addition, the store computer 4 is formed to be capable of mutually executing the online communication with the member server 9 through the special circuit 8 from a communication interface 432 connected through the bus 42. Moreover, the control unit 41 is connected with a keyboard 45, a display 46, a printer 47 and a hard disk drive apparatus (hereinafter, called as HDD) 48 through the bus 42 and an I/O equipment control unit 44.

Besides the various control programs enabling the CPU of the control unit 41 to act, a commodity master file F1, a store sales file F2, a point return rate change file F3 and the like are also stored in the HDD 48. The commodity master file F1 is a file storing commodity information such as a commodity name, a unit price, the predetermined point return rate (the third point return rate) for calculating the point number corresponding to the commodity purchase amount in the commodity sales processing in the real store, and the like, corresponding to the commodity code, and the store sales file F2 is a file storing sales registration data sent from each POS terminal 2.

In addition, in the present embodiment, the specified point return rate is set corresponding to the unit price of each commodity, but is not limited to that, for example, it can be also set in the form of setting a fixed point return rate for a currency amount.

FIG. 5 is a schematic diagram illustrating the data structure of the point return rate change file F3. As shown in FIG. 5, the point return rate change file F3 is a file storing the point return rate (the fourth point return rate different from the third point return rate) 12 changed corresponding to a specified condition (period) 11 serving as the second condition. As shown in FIG. 5, for example, the specified condition 11 is that the point return rate 12 is double and the like if the order and the purchase are carried out on Wednesday. In addition, as the specified condition 11, it is not limited to a week unit and can be also a date when a sports team in Japan is victorious, a date when a player wins a gold medal, and the like. Moreover, it can also last several days like a special sales period. Moreover, an element changing the point return rate into the point return rate 12 is not limited to a day unit, and can be also a month unit, an hour unit and a minute unit. Moreover, the specified condition 11 changing the point return rate into the point return rate 12 can be also not the time when the order is received, but is, for example, other condition such as the times that the customer carries out the order, and the like.

Moreover, in the present embodiment, the various control programs enabling the CPU of the control unit 41 to act carry out control, so that the point return rate is changed in the status that the order and the purchase of the commodity are carried out based on the specified condition. In the present embodiment, that the specified condition is Wednesday is taken for example. Afterwards, an example that the point return rate is double when the order and the purchase are carried out on Wednesday is described below.

Herein, the actions of the sales processing carried out between the POS terminal 2 and the store computer 4 when the commodity in the store of the POS system 7 is purchased are described. For example, when the commodity code attached to the commodity is read by the code scanner 206 of the POS terminal 2, the POS terminal 2 enquires the read commodity code towards the store computer 4. On the other hand, in the store computer 4, the commodity master file F1 is searched corresponding to the enquiry from the POS terminal 2, and the commodity information corresponding to the commodity code is readout and sent to the POS terminal 2.

Moreover, in the POS terminal 2, the commodity name or the unit price and the like from the store computer 4 are received, the registration according to a department category and the display towards the display 204 are carried out based on the enquired commodity code and the received commodity name, unit price and the like, or the printing processing is carried out by the printer 25, and further, the data subjected to sales registration are sent to the store computer 4. Afterwards, in the store computer 4 receiving the sales registration data from the POS terminal 2, the sales registration data are cumulatived in the store sales file F2. Thus, the sales registration data cumulatived in the store sales file F2 are sent to the member server 9 at a specified moment. In addition, the sales processing of the sales volume carried out on a net super based on the application server 6 is described below.

Next, the application server 6 is described. The application server 6 is a server apparatus for realizing a sales management system such as the so-called “net super” and the like, discloses a Web site for commodity sale on the WAN 5, and receives the order of the commodity purchase from the customer terminal 10. Moreover, the application server 6 uses the following printer 67 to output (print) a delivery slip for delivering the ordered commodity.

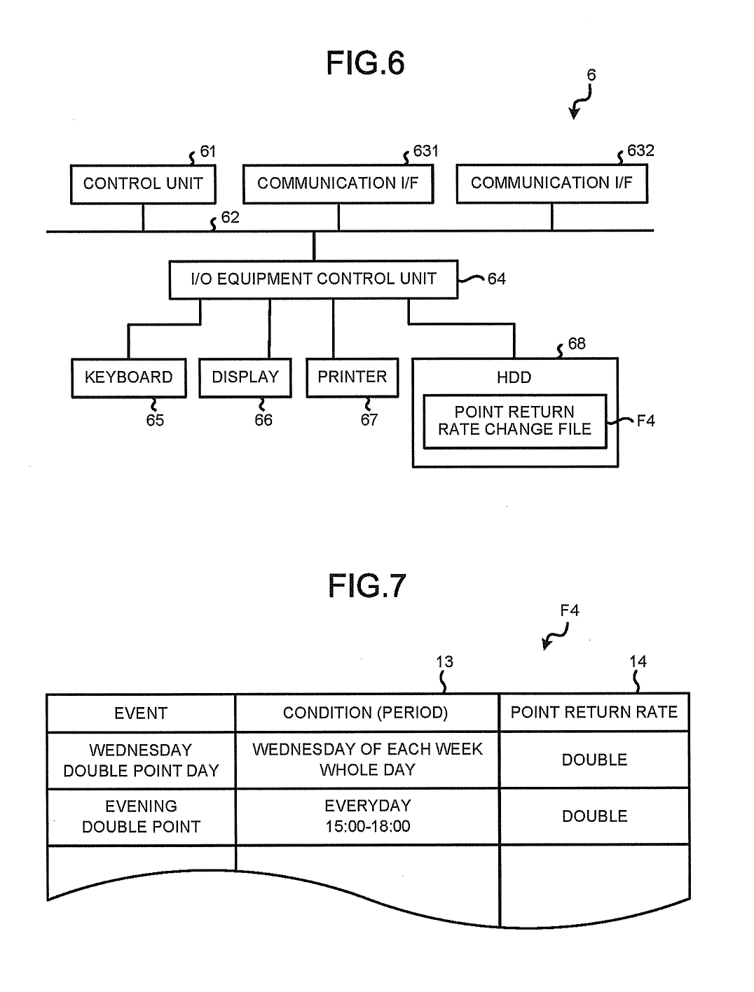

An electric system of the application server 6, for example, has a structure as shown in FIG. 6. Herein, FIG. 6 is a block diagram illustrating the structure of the electric system of the application server 6. The application server 6 is formed to be capable of mutually executing the online communication with the store computer 4 through the LAN 3 from a control unit 61 consisting of a computer comprising a CPU, an ROM, an RAM and the like and a communication interface 631 connected through a bus 62. In addition, it is formed to be capable of mutually executing the online communication with the customer terminal 10 through the WAN 5 from a communication interface 632 connected through the bus 62. Moreover, a keyboard 65, a display 66, the printer 67 and a hard disk drive apparatus (hereinafter, called as HDD) 68 are connected with the control unit 61 through the bus 62 and an I/O equipment control unit 64. In the HDD 68, besides various programs (such as a Web application, a database program and the like) for enabling the application server 6 to act as an order receiving system of the net super by synergistically acting with the CPU of the control unit 61, a control program for executing the following order receiving processing and slip printing processing is also stored. In addition, the printer 67 can be formed to be in the form of being internally arranged in the application server 6, and can be also formed to be in the form of being arranged outside the application server 6.

In the HDD 68, besides the various control programs enabling the CPU of, the control unit 61 to act, a point return rate change file F4 serving as the point return rate storage unit is also stored. FIG. 7 is a schematic diagram illustrating the data structure of the point return rate change file F4. As shown in FIG. 7, the point return rate change file F4 is a file storing the point return rate (the second point return rate different from the first point return rate) 14 changed corresponding to the specified condition (period) 13 serving as the first condition. The data stored in the point return rate change file F4 are the same as these in the point return rate change file F3 stored in the HDD 48 of the store computer 4. That is, the second point return rate 14 different from the predetermined first point return rate for calculating the point number corresponding to the commodity purchase amount and the first condition 13 changing the point return rate into the second point return rate 14 are stored in the point return rate change file F4. For example, the point return rate change file F4 can be changed when the point return rate change file F3 of the store computer 4 is changed each time, and can be also periodically changed when the business operation of the store is ended, and the like.

That is, the second point return rate 14 and the first condition 13 which are stored in the point return rate change file F4 are changed together with the fourth point return rate 12 and the second condition 11 changing the point return rate into the fourth point return rate 12 in the interlocking manner, and the fourth point return rate 12 is different from the predetermined third point return rate for calculating the point number in the commodity sales processing in the real store.

Herein, the network super service provided by the application server 6 is described. The application server 6 (control unit 61) acquires the commodity information such as the commodity name, the unit price and the like of the commodity constituting a sales object on the net super in the commodity included in the store of the POS system 7 from the store computer 4, and discloses the Web site for the commodity order revealing these commodity information on the WAN 5. In addition, the layout of the Web site and a mechanism to which the commodity order relates are not particularly limited, but a mechanism (such as user authentication and the like) inputting the member number for recognizing each customer is previously arranged.

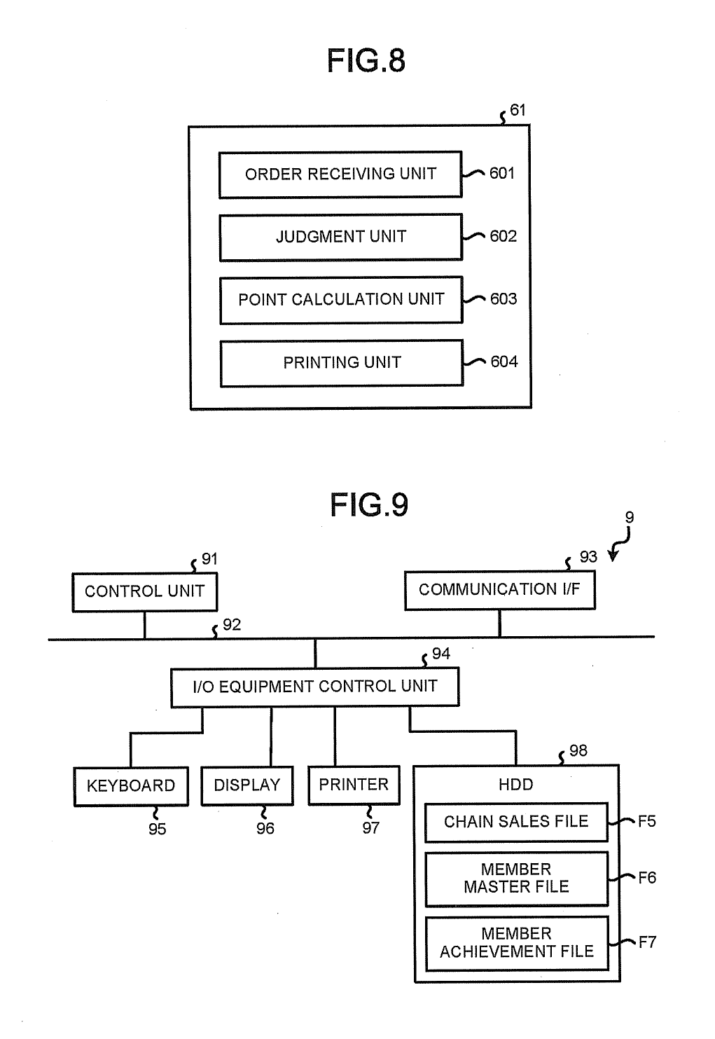

In order to issue the delivery slip, the application server 6 (control unit 61) comprises the software structure as shown below. FIG. 8 is a diagram illustrating the software structure of the control unit 61. As shown in FIG. 8, the control unit 61 comprises an order receiving unit 601 serving as the order receiving unit, a judgment unit 602 serving as the judgment unit, a point calculation unit 603 serving as the point calculation unit, and a printing unit 604 serving as a printing unit.

The order receiving unit 601 receives the order of the commodity purchase from the customer terminal 10 by which the customer carries out an operation through the Web site disclosed on the WAN 5.

The judgment unit 602 judges whether or not the received order is consistent with the condition 13 changing the point return rate stored in the point return rate change file F4. For example, in the status that such a content that Wednesday as the date when the order is received is taken as the condition 13 changing the point return rate is set in the point return rate change file F4, if the order is received in the morning on Wednesday, the judgment unit 602 judges that the received order is consistent with the condition 13 changing the point return rate. That is, in the status that such a content that Wednesday as the date when the order is received is only taken as the condition 13 changing the point return rate is set in the point return rate change file F4, if the date when the order is received is a date except Wednesday, it is changed into a usual point return rate, and if the date when the order is received is Wednesday, it is changed into the point return rate (such as the point return rate which is double the usual one) 14 corresponding to the condition 13.

Particularly, in the present embodiment, for the point return rate, that one point is usually granted to each sales volume of 200 yen is taken for example. Afterwards, the portion below 200 yen is abandoned. Thus, for example, in the status that the total purchase amount of the customer is 5220 yen, 26 points are granted.

Moreover, if the date when the order is carried out is Wednesday, the point return rate is granted with the double of the usual one, and therefore, 2 points are granted to each sales volume of 200 yen. For example, if the total purchase amount of the customer is 5220 yen, 52 points are granted. In addition, in the present embodiment, an example using the point return rate derived after multiplying the usual point return rate by ‘2’ if it is Wednesday is illustrated, and the arithmetic except multiplication, such as the addition and the like of the specified point number, can be also carried out.

Thus, in the status that it is judged to be inconsistent with the condition 13 changing the point return rate stored in the point return rate change file F4, the point calculation unit 603 calculates the point number corresponding to the commodity purchase amount by using the usual point return rate, and in the status that it is judged to be consistent with the condition 13 changing the point return rate stored in the point return rate change file F4, the point calculation unit 603 calculates the point number corresponding to the commodity purchase amount by using the point return rate (such as the point return rate which is double the usual one) 14 corresponding to the condition 13.

The printing unit 604 prints the detail of the commodity taken as a purchased object due to the order and the calculated point number on the delivery slip. In addition, in the status that the date when the order is carried out is consistent with the condition 13 changing the point return rate stored in the point return rate change file F4, the printing unit 604 outputs the slip on which the information of a content denoting that the point return rate is changed is printed. Moreover, the delivery slip is output from the printer 67.

However, the statuses that the delivery slip is delivered after Wednesday when the customer considers that the point return rate on Wednesday is double to carry out the order on Wednesday are more. In such a status, in the delivery slip only recording the point as usual, the customer cannot know whether or not the point is granted with the proper point return rate. Therefore, the printing unit 604 of the present embodiment is formed to record a content that the point return rate is double on the delivery slip if the order is carried out on Wednesday. Thus, no matter when the delivery slip is delivered to the customer, whether or not the point is granted with the proper point return rate can be confirmed.

Besides recording a sales price on the delivery slip when the order is received, that is, when the commodity is sold, the application server 6 to which the present embodiment relates also prints the point number calculated based on the sales volume and the point return rate.

The granted point is recorded on the delivery slip by the application server 6. Afterwards, in the status that the point return rate is changed, the application server 6 records the content on the delivery slip. Thus, it is designed to be that the processing is carried out the same as a sales achievement in the store in the following sales processing by recording the point number corresponding to the sales volume.

Afterwards, in the store of the POS system 7, the commodity whose order is received is delivered from the store to a customer residence (not shown in figures) by using a delivery mechanism according to the commodity name and a quantity which are recorded in the delivery slip. Thus, the commodity sold in the net super is delivered from an actual store serving as the supply cradle of the commodity to the customer residence.

Next, the member server 9 is described. An electric system of the member server 9 has a structure as shown in FIG. 9. Herein, FIG. 9 is a block diagram illustrating the structure of the electric system of the member server 9. The member server 9 comprises a control unit 91 consisting of a computer comprising a CPU, an ROM, an RAM and the like, and moreover, is formed to be capable of mutually executing the online communication with the store computer 4 through the special circuit 8 from a communication interface 93 connected through a bus 92. Moreover, a keyboard 95, a display 96, a printer 97 and a hard disk drive (hereinafter, called as HDD) 98 are connected with the control unit 91 through the bus 92 and an I/O equipment control unit 94.

Besides the control program enabling the CPU of the control unit 91 to act, a chain sales file F5, a member master file F6, a member achievement file F7 and the like are also stored in the HDD 98.

The chain sales file F5 is a file storing the sales registration data sent from the store computer 4 of each store. The member master file F6 is a file storing member information (customer name, gender, birthday, resistance, telephone number and the like) for each member customer. The member achievement file F7 is a file storing sales achievement information for each member customer. The sales achievement information is cumulatived and updated at the specified moment based on the chain sales file F5 and the like.

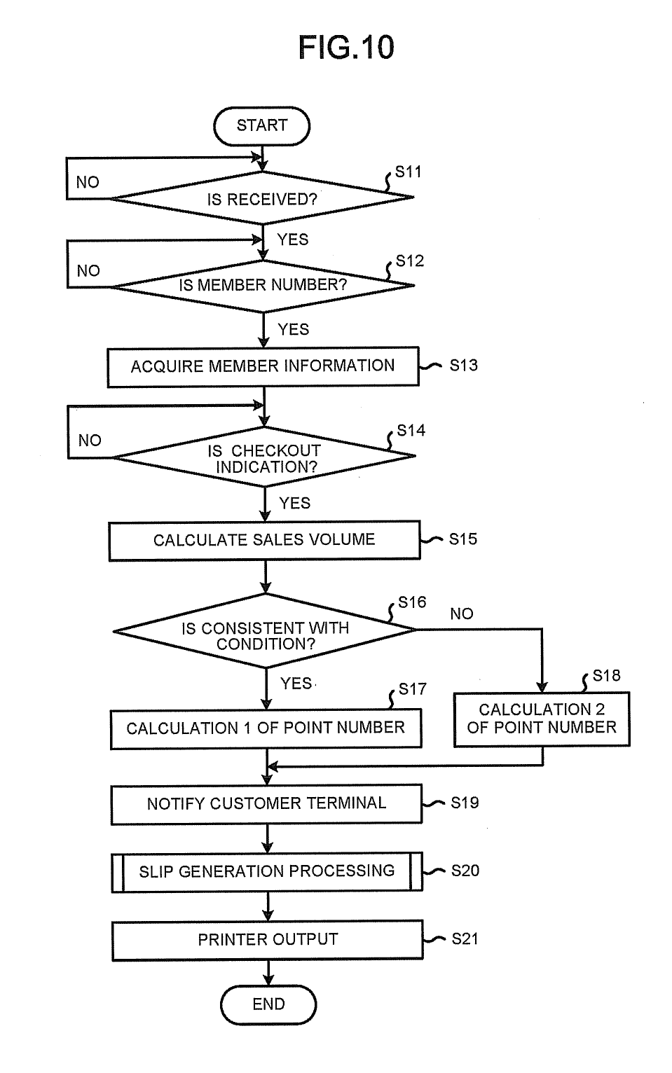

Hereinafter, actions when the commodity is sold in the net super of the store of the POS system 7 will be described with reference to FIG. 10 to FIG. 15.

First, the actions when the order of the commodity purchase is received from the customer (customer terminal 10) through the Web site disclosed by the application server 6 on the WAN 5 are described with reference to FIG. 10. Herein, FIG. 10 is a flow chart illustrating the procedures of the order receiving processing executed when the order of the commodity purchase is received. In addition, as the premise of the present processing, the Web site revealing the commodity information (such as the commodity name or the unit price, the point return rate and the like) of the commodity constituting the sales object in the net super is previously disclosed on the WAN 5.

The control unit 61 is standby before the Web site disclosed on the WAN 5 is accessed from the customer terminal 10 (ACT S11; No). Herein, when the access to the Web site is received from the customer terminal 10 (ACT S11; Yes), the control unit 61 displays a screen urging to input the member number and is standby before the input of the member number is carried out (ACT S12; No).

On the other hand, in the status that the input of the member number is received from the customer terminal 10 (ACT S12; Yes), the control unit 61 acquires the member information corresponding to the member number from the member master file F6 of the member server 9 through the store computer 4 (ACT S13).

Afterwards, the order receiving unit 601 of the control unit 61 receives the selection of the commodity constituting the purchased object from the customer terminal 10 through the Web site. After the commodity is selected, the order receiving unit 601 judges whether or not the indication of a content carrying out checkout is received from the customer terminal 10 (ACT S14). In the status that the indication of the content carrying out the checkout is not received (ACT S14; No), the selection of the commodity is directly received.

Afterwards, in the status that the indication of the content carrying out the checkout is received (ACT S14; Yes), the order receiving unit 601 calculates the sales volume of the commodity based on the commodity information of the commodity taken as the purchased object (ACT S15). Subsequently, the judgment unit 602 judges whether or not the received order is consistent with the condition 13 changing the point return rate stored in the point return rate change file F4 (ACT S16).

Afterwards, in the status that the judgment unit 602 judges that the received order is inconsistent with the condition 13 changing the point return rate (ACT S16; No), the point calculation unit 603 uses the calculated sales volume and the usual point return rate to calculate the point number (ACT S18).

On the other hand, in the status that the judgment unit 602 judges that the received order is consistent with the condition 13 changing the point return rate (ACT S16; Yes), the point calculation unit 603 uses the calculated sales volume and the point return rate (such as a double point return rate) 14 corresponding to the condition 13 to calculate the point number (ACT S17).

Subsequently, the order receiving unit 601 notifies that a purchase procedure is ended to the customer by providing the Web page showing the sales volume calculated in ACT S15, the point number calculated in ACT S17 or ACT S18 and the summary of the commodity taken as the purchased object to the customer terminal 10 (ACT S19).

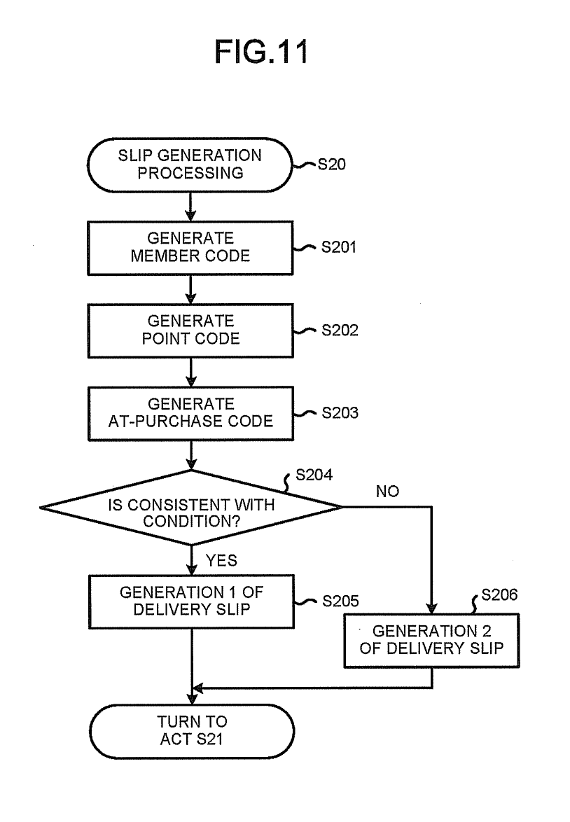

In addition, the printing unit 604 executes the slip generation processing for generating the delivery slip relevant with the delivery of the commodity receiving the order from the customer terminal 10 (ACT S20). Hereinafter, the slip generation processing in ACT S20 will be described with reference to FIG. 11.

FIG. 11 is a flow chart illustrating the ACTs of the slip generation processing. First, the printing unit 604 generates a code (hereinafter, called as “member code”) denoting the member number received in ACT S12 (ACT S201). Further, the printing unit 604 generates a code (hereinafter, called as “point code”) denoting the point number calculated in ACT S17 or ACT S18 (ACT S202).

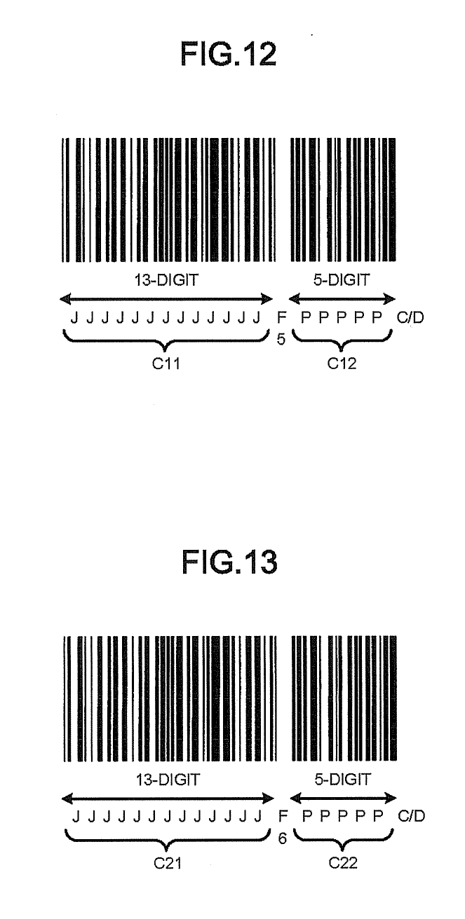

FIG. 12 is a diagram illustrating an example of the member code. Moreover, FIG. 13 is a diagram illustrating an example of the point code. In addition, in FIG. 12 and FIG. 13, examples setting a code system as an 18-digit barcode are illustrated.

As shown in FIG. 12, the member code consists of a 13-digit first code area C11 and a 5-digit second code area C12, and the member number of one customer is denoted by using an 18-digit code area of the first code area C11 and the second code area C12. Moreover, a code (F) existing between the first code area C11 and the second code area C12 is taken as flag information. A value denoting that the barcode is the member code, that is, the member number input at the sale through the net super, is input into the flag information. In addition, in the present embodiment, the flag information set in the member code is set as “5”, but is not limited to the value. Moreover, the proportion of code numbers constituting the first area and the second area is not limited to that.

On the other hand, as shown in FIG. 13, similar to the member code, the point code consists of a 13-digit first code area C21 and a 5-digit second code area C22. Herein, the first code area C21 becomes a fixed portion, and the second code area C22 is used to denote the point number. Moreover, a code (F) existing between the first code area C21 and the second code area C22 is the flag information, and a value denoting that the barcode is the point code, that is, a value denoting the point granted due to the sale on the net super, is input into the code (F). In addition, in the present embodiment, the flag information set in the pint code is set as “6”, but is not limited to the value, so long as the value is different from the flag information of other code. Moreover, the proportion of the code numbers constituting the first area and the second area is not limited to that.

Return to FIG. 11, the printing unit 604 generates a code (hereinafter, called as “at-purchase code”) including the commodity code (a country code, a manufacturer code, a commodity item code) and a unit price code denoting a commodity unit price at a purchase time point for each commodity taken as the purchased object in ACT S14 (ACT S203). Herein, the commodity code means a group of the country code, the manufacturer code and the commodity item code included in a JAN code usually used in the POS system.

In the present embodiment, similar to the member code and the point code, the at-purchase code is denoted by using the 18-digit barcode consisting of the first code area and the second code area. Particularly, the commodity code is denoted by using the 13-digit first code area, and the unit price code is denoted by using the second code area. The flag information included in the at-purchase code is set as the value different from other code, and in the present embodiment, for example, “4” is used. In addition, the flag information set in the at-purchase code functions as the unit price of the commodity denoted by the commodity code included in the at-purchase code and indication information indicating the unit price denoted by using the unit code at the following sales processing.

Next, the judgment unit 602 judges whether or not the received order is consistent with the condition 13 changing the point return rate stored in the point return rate change file F4 (ACT S204).

In the status that the judgment unit 602 judges that the received order is inconsistent with the condition 13 changing the point return rate (ACT S204; No), the printing unit 604 inputs the member information acquired in ACT S13, the commodity information of each commodity taken as the purchased object received in ACT S14, each code generated in ACTs S201-S203, and the like, to a specified format and generates the delivery slip (ACT S206).

On the other hand, in the status that the judgment unit 602 judges that the received order is consistent with the condition 13 changing the point return rate (ACT S204; Yes), the printing unit 604 inputs the message (for example, “the point being double”) of a content that it is changed into the point return rate (such as the double point return rate) 14 corresponding to the condition 13 together with the member code generated in ACTs S201-S203 and denoting the member information, the point code denoting the point number and the at-purchase code of each commodity taken as the purchased object to the specified format, and generates the delivery slip (ACT S205). Afterwards, after the processing in ACT S205 or ACT S206 is ended, it processes to the processing in ACT S21.

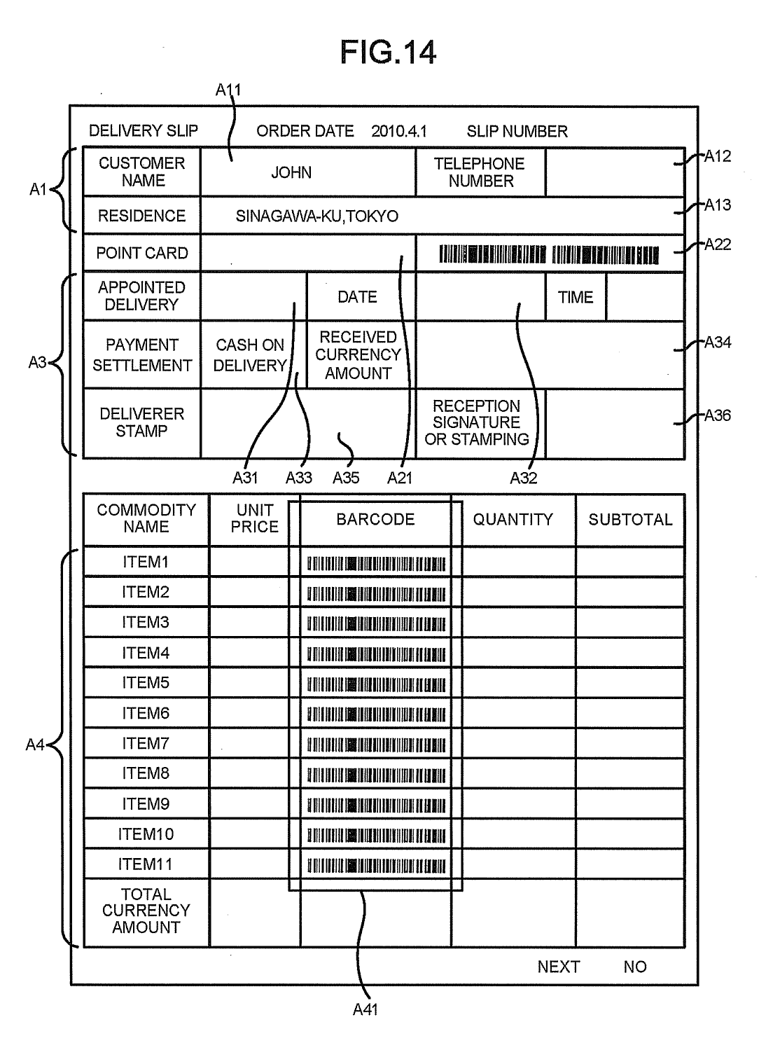

Next, two types of the generated delivery slips are described. FIG. 14 is a diagram illustrating an example of the delivery slip generated in the processing in ACT S206. The delivery slip is a delivery slip as the order is carried out on a day except Wednesday, and therefore, the point number is granted according to the usual point return rate (1 point for 200 yen).

An area A1 becomes an area into which the member information of the customer taken as a delivery destination is input. In the example in FIG. 14, the name of the customer is input into an area A11 in the member information acquired in ACT S13, the telephone number of the customer is input into an area A12 in the member information acquired in ACT S13, and the residence of the customer taken as the delivery destination is input into an area A13 in the member information acquired in ACT S13. In addition, in the status that the customer additionally appoints the residence and the telephone number of the delivery destination when the commodity is ordered, these appointed information is input into the corresponding area.

An area A21 is an area into which the member number of the customer and the point number granted in the present order are input. Particularly, a 18-digit member number and a 6-digit point number are input into the area A21 with a plaintext. In the 6-digit point number, five digits at high digits are the point number, and one digit at a low digit is a Check Digit. That is, “000261” is a digital sequence after “00026” taken as the point granted in the present order is combined with the Check Digit “1”. Thus, in the area A21, the point number in the point code is only recorded, and the recording of the fixed portion in the point code is omitted.

The member code and the point code generated in ACTs S201 and S202 are input into an area A22. In addition, in the example in FIG. 14, the member code and the point code are set in the form of being transversely arranged along a paper surface to be configured, but are not limited to that, and can be also in the form of being longitudinally configured into two groups along the paper surface.

Delivery information needed at delivery is input into an area A3. In the example in FIG. 14, as the delivery information, information appointing a delivery date, information appointing delivery time and information appointing a settlement method are input into areas A31-A33. These delivery information is the delivery information additionally indicated from the customer (customer terminal 10) when the commodity is ordered. The total amount of the commodity taken as the purchased object is input to an area A34 as a collection currency amount. Moreover, an area A35 is a blank area set for the signature or the stamping of a deliverer, and an area A36 is a blank area set for the reception signature or stamping of the customer.

The detail such as the commodity name of each commodity taken as the purchased object, the unit price at the purchase, the quantity, a subtotal, a total currency amount and the like is input into an area A4. Herein, in an area A41, the at-purchase code of each commodity taken as the purchased object is input for each commodity.

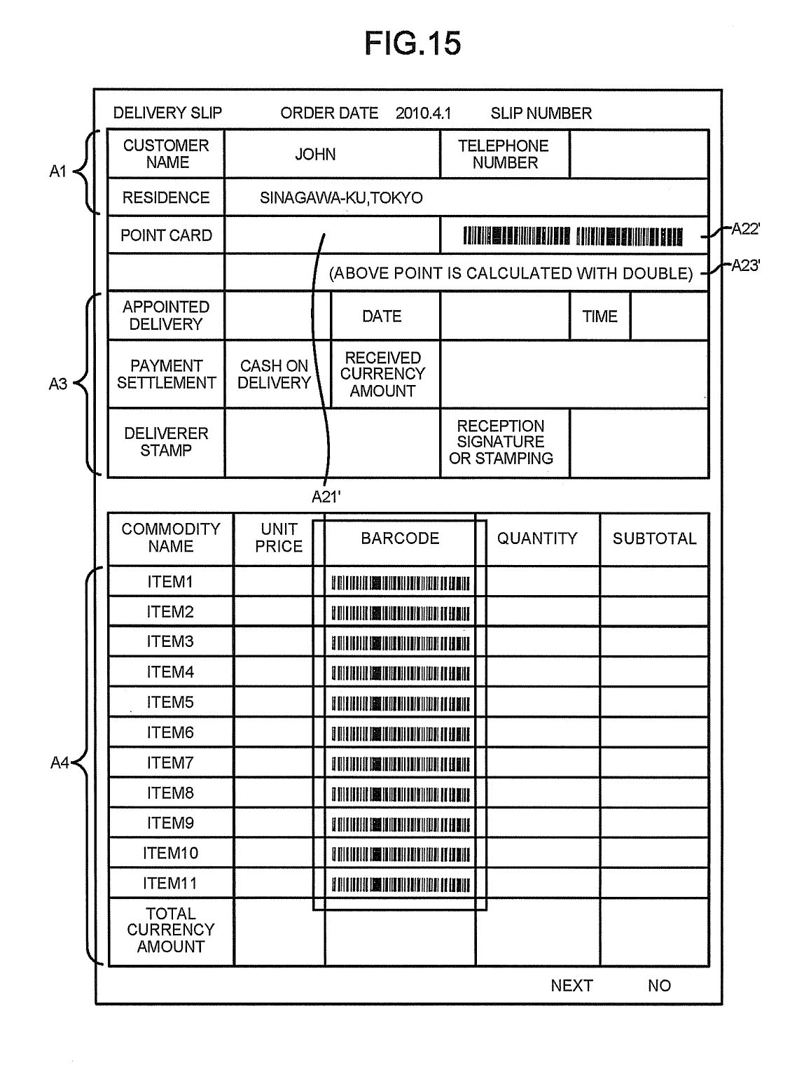

FIG. 15 is a diagram illustrating an example of the delivery slip generated in the processing in ACT S205. For the delivery slip, in the status that such a content that Wednesday as the date when the order is received is taken as the condition 13 changing the point return rate is set in the point return rate change file F4, as the delivery slip is the delivery slip of the order carried out on Wednesday, the point number is granted with the point return rate (such as the point return rate that is double the usual one (2 points for 200 yen)) 14 corresponding to the condition 13. In addition, the area A1, the area A3 and the area A4 are the same as FIG. 14, and therefore, descriptions are omitted.

An area A21′ is an area into which the member number of the customer and the point number granted in the present order are input. Particularly, the 18-digit member number and the 6-digit point number are input into the area A21′ with the plaintext. In addition, in the 6-digit point number, the five digits at the high digits are the point number, and one digit at the low digit is the Check Digit. That is, “000523” is a digital sequence after “00052” taken as the point granted with the point return rate which is double the usual one in the present order is combined with the Check bit “3”. Thus, in the area A21′, the point number in the point code is also only recorded, and the recording of the fixed portion in the point code is omitted.

The member code and the point code generated in ACTs S201 and S202 are input into an area A22′.

“The above point is calculated with double.” A message as a content that the point is double is input into an area A23′. The area A23′ is an area set only in the status (for example, in the status that the order is carried out on Wednesday) that the received order is consistent with the condition 13 changing the point return rate stored in the point return rate change file F4. The area A23′ is particularly set, as the above message is input, even though the delivery slip is received after Thursday, the customer can also confirm that the point return rate in the order carried out on Wednesday is double.

Return to FIG. 10, the printing unit 604 uses the printer 67 to output the delivery slip generated in the slip generation processing in ACT S20 (ACT S21), and ends the present processing. In addition, in the present processing, it is set in the form that the input of the member number is immediately received after the access, but is not limited to that, and it can be also set in the form that the input of the member number is received at the checkout and the like, so long as it is before the processing in ACT S20.

The delivery slip output through the above processing together with each commodity taken as the purchased object picked up in the store is delivered to the deliverer to be delivered to the customer residence of the delivery destination. After the delivery is ended, the delivery slip on which the customer carries out the reception signature or stamping is returned to the store of the POS system 7 and is applied to the sales processing carried out by the POS terminal 2 at a random moment.

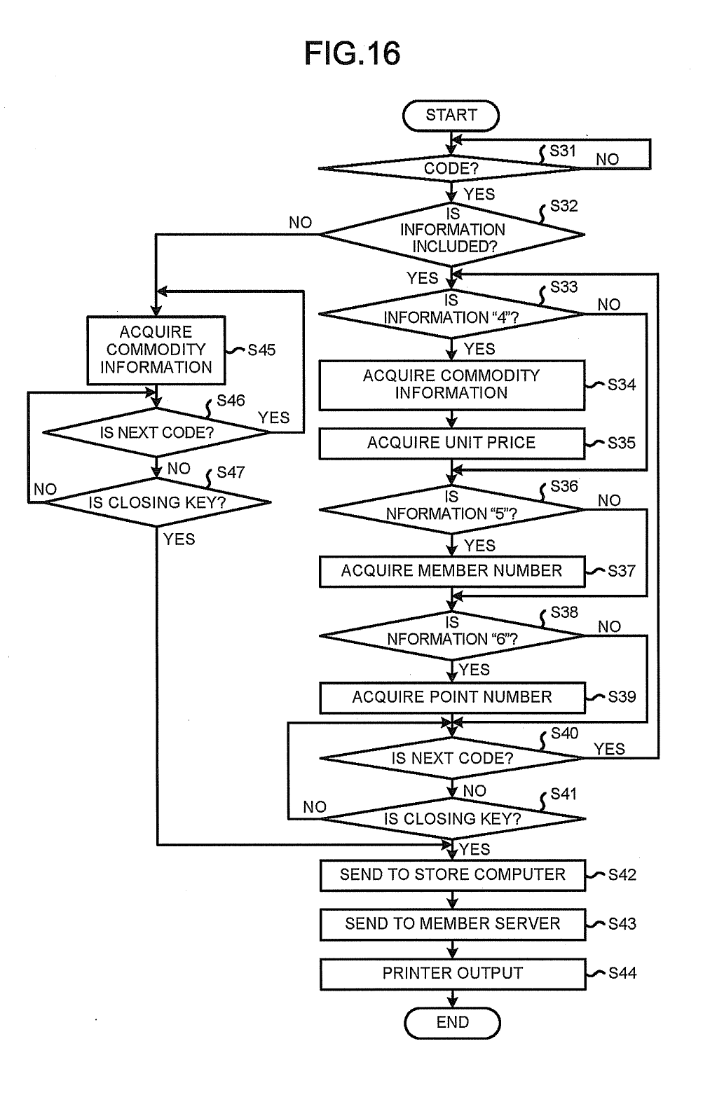

Hereinafter, the sales processing carried out in the POS terminal 2 will be described with reference to FIG. 16. Herein, FIG. 16 is a flowchart illustrating the procedures of the sales processing executed in the POS terminal 2.

First, the control unit 21 is standby before the commodity code attached to the commodity or any code recorded on the delivery slip is read by the code scanner 206 (ACT S31; No). Herein, the control unit 21 judges whether or not the flag information denoting “4”, “5” or “6” is included in the code (ACT S32) when the reading of the any code is detected (ACT S31; Yes).

In ACT S32, the control unit 21 judges that an object relevant with the sales processing is the sales volume in the net super when judging that the flag information is any one of “4”, “5” and “6” (ACT S32; Yes), and executes the processing corresponding to each code.

In the status that the flag information included in the code is “4” (ACT S33; Yes), the control unit 21 judges that the code is the at-purchase code, takes the commodity code included in the at-purchase code as a keyword and acquires the commodity information such as the commodity name and the like from the store computer 4 (ACT S34). Moreover, in order to calculate the sales volume, the control unit 21 acquires the commodity unit price included in the at-purchase code (ACT S35). In addition, it can be also set in the form that the commodity name and its commodity unit price are displayed on the display 204 at the moment.

Moreover, in the status that the flag information included in the code is “5” (ACT S33; No→ACT S36; Yes), the control unit 21 judges that the code is the member code and acquires the member number included in the member code (ACT S37).

Moreover, in the status that the flag information included in the code is “6” (ACT S33; No→ACT S36; No→ACT S38; Yes), the control unit 21 judges that the code is the point code and acquires the point number included in the point code (ACT S39).

Next, the control unit 21 judges whether or not a next code is read by the code scanner 206 (ACT S40). Herein, in the status that the input of a new code is detected (ACT S40; Yes), it returns to ACT S33 again to execute the processing corresponding to each code. Moreover, in ACT S40, in the status that the input of the next code cannot be detected (ACT S40; No), the control unit 21 judges whether or not a “closing key” denoting the ending of the input of the code is input through the keyboard 202 (ACT S41).

In ACT S41, in the status that the input of the “closing key” cannot be detected (ACT S41; No), it returns to ACT S40 again. Moreover, in the status that the input of the “closing key” is detected (ACT S41; Yes), the control unit 21 calculates the sales volume from the commodity unit price for each commodity acquired in ACT S35 and sends it to the store computer 4 as the sales registration data, and thus, the sales registration data are accumulated in the store sales file F2 of the store computer 4 (ACT S42).

Thus, the control unit 21 calculates the sales volume for the sales processing in the net super based on the commodity unit price included in the at-purchase code, and therefore, even though the commodity price managed by the store computer 4 is changed, the sales calculation can be also carried out by using the price when the order is carried out in the net super. In such a status, as the commodity price managed by the store computer 4 is not used for the calculation of the sales volume, it can be also set in the form that the commodity price is not acquired from the store computer 4 in ACT S34.

Next, the control unit 21 sends the group of the member number acquired in ACT S37 and the point number acquired in ACT S39 to the member server 9 through the store computer 4, thus, cumulatives the point number in the shopping achievement information of the member number stored in the member achievement file F7 (ACT S43), and transfers to the processing in ACT S44. In addition, in the status that a shopping cumulative currency amount is managed as the shopping achievement information in the member achievement file F7, the sales volume is sent to the member server 9 in a manner of being matched with the member number and the point number.

Thus, the control unit 21 cumulatives the point number included in the point code in the shopping achievement information for the sales processing in the net super, and therefore, even though the commodity price and the point return rate which are managed by the store computer 4 are changed, the point number corresponding to the sales volume when the order is carried out in the net super can be also reflected towards each customer. In addition, in such a status, as the point return rate managed by the store computer 4 is not used, it can be also set in the form that the point return rate is not acquired from the store computer 4 in ACT S34.

Next, in ACT S44, the control unit 21 outputs the detail (receipt) of the present sales processing from the printer 25 based on the commodity name of each commodity and its price, sales volume and the like, so as to end the present processing.

On the other hand, in ACT S32, if the flag information is judged not to be any one of “4”, “5” and “6” (ACT S32; No), the control unit 21 judges that the object relevant with the sales processing is the sales volume in the store. Herein, the code system of the commodity code is not limited to the usually used JAN code, and can be also the barcode the same as the above member code and the like. In addition, in the status that the barcode the same as the member code and the like is used, the value different from the flag information of other code is granted to the flag information of the barcode.

The control unit 21 takes the commodity code read by using the code scanner 206 as the keyword when judging that the object relevant with the sales processing is the sales volume in the store, and acquires the point return rate 12 which is changed corresponding to the commodity information such as the commodity name, the commodity unit price, the point return rate and the like managed by the commodity master file F1 from the store computer 4 and the specified condition (period) 11 managed by the point return rate change file F3 (ACT S45). At the moment, it can be also set in the form that the commodity name and its commodity unit price and the like are displayed on the display 204.

Next, the control unit 21 judges whether or not the next code (commodity code) is read by the code scanner 206 (ACT S46). Herein, in the status that the input of the new code is detected (ACT S46; Yes), it returns to ACT S45 again. Moreover, in ACT S46, in the status that the input of the next code cannot be detected (ACT S46; No), the control unit 21 judges whether or not the input of the “closing key” is received (ACT S47).

In ACT S47, in the status that the input of the “closing key” cannot be detected (ACT S47; No), it returns to the processing in ACT S46 again. Moreover, in the status that the input of the “closing key” is detected (ACT S47; Yes), the control unit 21 cumulatives the sales volume from the commodity unit price for each commodity acquired in ACT S45 and sends it to the store computer 4 as the sales registration data, and thus, the sales registration data are cumulatived in the store sales file F2 of the store computer 4 (ACT S42).

Moreover, in the status that the member number is read from the member card carried by the customer by the card reader/writer 205, the control unit 21 calculates the point number from the point return rate according to the sales volume, sends the point number together with the member number to the member server 9 through the store computer 4, and thus, cumulatives the point number in the shopping achievement information of the member number stored in the member achievement file F7 (ACT S43).

Thus, for the sales volume in the store, as described above, the calculation of the sales volume and the calculation of the point number are carried out based on the point return rate 12 changed corresponding to a newest commodity unit price and the point return rate managed by the commodity master file F1 of the store computer 4 and the specified condition (period) 11 managed by the point return rate change file F3.

Next, in ACT S44, the control unit 21 outputs the detail (receipt) of the present sales processing from the printer 25 based on the commodity name of each commodity and the price, the total sales volume and the like of the commodity, so as to end the present processing.

As described above, according to the present embodiment, in the status that the order received from the terminal connected through the network is judged to be consistent with the first condition 13 by referring to the point return rate change file F4 storing the second point return rate 14 different from the predetermined first point return rate for calculating the point number corresponding to the commodity purchase amount and the first condition 13 changing the point return rate into the second point return rate 14, the point number corresponding to the commodity purchase amount of the order is calculated by using the second point return rate 14, moreover, the second point return rate 14 and the first condition 13 which are stored in the point return rate change file F4 are changed together with the fourth point return rate 12 different from the predetermined third point return rate for calculating the point number in the commodity sales processing in the real store and the second condition 11 changing the point return rate into the fourth point return rate 12 in the interlocking manner, thus, it also interlocks with an event that the point return rate in the real store rises in the net super, and therefore, the purchase desire of the user in the net super can be promoted.

Moreover, according to the present embodiment, in the status that the point return rate is increased as the specified condition is met, the message of a content that the point return rate is increased is recorded in the delivery lip. Thus, the user can confirm the status that the point return rate is increased according to the condition when the order is carried out.

Afterwards, the point code whose point is granted with the increased point return rate together with the message is granted to the delivery slip. Afterwards, at the sales processing, the point number denoted by the point code recorded (printed) on the delivery slip is used.

In the present embodiment, as the processing is carried out by using the above delivery slip, even in the status that the date when the order is carried out is different from the date when the sales processing is carried out, the granting of the point number can be also carried out based on the condition when the order is carried out. Thus, the proper point granting can be carried out.

The granting and the like of these points can be realized by being encoded into the code which can be read by using the card reader/writer 205 of the POS terminal 2 and being recorded (printed) on the delivery slip, and therefore, it can be easily led in an existing POS system 7.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, in the above embodiment, it is set to be that the point return rate change file F4 the same as the point return rate change file F3 of the store computer 4 is stored in the HDD 68 of the application sever 6, but is not limited to that. For example, the point return rate change file F4 can be also not stored in the HDD 68 of the application server 6, and the application server 6 accesses the point return rate change file F3 of the store computer 4 as required to carry out the processing. Thus, the application server 6 can always utilize the newest information. In such a status, the second point return rate 14 and the fourth point return rate 12 become the same to interlock substantially, and the first condition 13 and the second condition 11 become the same to interlock substantially.

Moreover, in the above embodiment, the delivery slip on which the customer carries out the reception signature or the stamping is taken as the object in the sales processing, but is not limited to that, and the delivery slip which is just output by the application server 6 can be also taken as the object in the processing.

Moreover, in the above embodiment, the member code, the point code and the at-purchase code are set as the barcodes, but are not limited to that, for example, can be also set in the form of other barcodes and two-dimension codes which are readable for the card reader/writer 205 of the POS terminal 2.

Moreover, in the above embodiment, it is set in the form that the store computer 4 uniformly manages the commodity master file F1 and the store sales file F2, but is not limited to that, for example, can be also set in the form that each POS terminal 2 respectively maintains the commodity master file F1 and the store sales file F2 and carries out the integration of the data on the commodity master file F1 and the store sales file F2 which are managed by the store computer 4 at the specified moment.

In addition, the program executed by the POS terminal 2 and the application server 6 of the above embodiment is provided by being preinstalled in the recording medium included in each apparatus, but is not limited to that, and can be also formed to be provided by being recorded in a computer-readable recording medium such as a CD-ROM, a floppy disk (FD), a CD-R, a DVD (Digital Versatile Disk) and the like with a file in an installable form or an executable form. In addition, the recording medium is not limited to the computer or a medium independent of an assembly system, and also includes a recording medium which is stored or temporarily stored by downloading a program transferred through an LAN or the internet and the like.

Moreover, it can be also formed to be that the program executed by the POS terminal 2 and the application server 6 of the above embodiment is stored in a computer connected with a network such as the internet and the like and is downloaded by a network path to be provided, and can be also formed to be provided or distributed by the network path such as the internet and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
an order receiving unit configured to receive the order of commodity purchase from a terminal connected through a network;
a judgment unit configured to refer to a point return rate storage unit which stores a second point return rate different from a predetermined first point return rate for calculating a point number corresponding to a commodity purchase amount and a first condition for changing into the second point return rate to judge whether or not the received order is consistent with the first condition; and
a point calculation unit configured to calculate the point number corresponding to the commodity purchase amount of the order by using the first point return rate in a status that the judgment unit judges that the received order is inconsistent with the first condition, and calculate the point number corresponding to the commodity purchase amount of the order by using the second point return rate in a status that the judgment unit judges that the received order is consistent with the first condition, wherein
the second point return rate and the first condition which are stored in the point return rate storage unit are changed together with a fourth point return rate different from a predetermined third point return rate for calculating the point number in the commodity sales processing in a real store and a second condition for changing into the fourth point return rate.

2. The information processing apparatus according to claim 1, further comprising:
a printing unit configured to print the detail and the point number of a commodity taken as a purchased object due to the order, and output a slip on which the information of a content denoting that the point return rate is changed into the second point return rate is printed in the status that the judgment unit judges that the order is consistent with the first condition.

3. The information processing apparatus according to claim 2, wherein
the point calculation unit uses the second point return rate derived by multiplying the first point return rate by a specified numerical value to calculate the point number corresponding to the commodity purchase amount in the status that the judgment unit judges that the order is consistent with the first condition; and
the printing unit outputs a slip on which a content that the specified numerical value is multiplied is printed in the status that the judgment unit judges that the order is consistent with the first condition in order to denote that the point return rate is changed into the second point return rate.

4. An information processing method, comprising:
receiving the order of commodity purchase from a terminal connected through a network;
referring to a point return rate storage unit that stores a second point return rate different from a predetermined first point return rate for calculating a point number corresponding to a commodity purchase amount and a first condition for changing into the second point return rate and the second point return rate and the first condition which are stored in the point return rate storage unit are changed together with a fourth point return rate different from a predetermined third point return rate for calculating the point number in the commodity sales processing in a real store and a second condition for changing into the fourth point return rate, to judge whether or not the received order is consistent with the first condition; and
calculating the point number corresponding to the commodity purchase amount of the order by using the first point return rate in a status that is judged that the received order is inconsistent with the first condition, and calculating the point number corresponding to the commodity purchase amount of the order by using the second point return rate in a status that is judged that the received order is consistent with the first condition.

5. The information processing method according to claim 4, further comprising:
printing the detail and the point number of a commodity taken as a purchased object due to the order; and
outputting a slip on which the information of a content denoting that the point return rate is changed into the second point return rate is printed in the status that is judged that the order is consistent with the first condition.

6. The information processing method according to claim 5, wherein
using the second point return rate derived by multiplying the first point return rate by a specified numerical value to calculate the point number corresponding to the commodity purchase amount in the status that is judged that the order is consistent with the first condition; and
outputting a slip on which a content that the specified numerical value is multiplied is printed in the status that is judged that the order is consistent with the first condition in order to denote that the point return rate is changed into the second point return rate.
